(19) United States
(12) Patent Application Publication
(10) Pub. No.: US 2018/0018578 A1
(43) Pub. Date: Jan. 18, 2018

(54) APPARATUS ASSISTING WITH DESIGN OF OBJECTIVE FUNCTIONS

(71) Applicant: INTERNATIONAL BUSINESS MACHINES CORPORATION, Armonk, NY (US)

(72) Inventor: Takayuki Yoshizumi, Tokyo (JP)

(21) Appl. No.: 15/210,280

(22) Filed: Jul. 14, 2016

(51) Int. Cl. G06N 99/00; G06N 5/04

(52) U.S. Cl. CPC G06N 99/005; G06N 5/048

(57) ABSTRACT

Provided is an apparatus, method, and computer-readable storage medium for acquiring learning data that includes an evaluation of evaluation targets; generating a constraint condition to be satisfied by a value of an evaluation function that includes a weighting for each of a plurality of evaluation criteria of the evaluation target and an unknown term for each evaluation target corresponding to an unknown evaluation criterion that is not among the plurality of evaluation criteria, based on the learning data; determining a value of the unknown term and the weighting for each evaluation criterion in the evaluation function in a manner that satisfies the constraint condition; extracting a set of evaluation targets for which an evaluation of each evaluation criterion is opposite of an evaluation based on the unknown term, from among the plurality of evaluation targets; and outputting the extracted set of evaluation targets.

### BACKGROUND

### Technical Field

The present invention relates to an apparatus assisting with the design of objective functions.

### Description of the Related Art

A method is known for using an evaluation function to evaluate solutions for optimization problems or the like. For example, a technique is known that includes adjusting a weighting of an evaluation function such that a quantitative evaluation of a solution made by a person, e.g. an evaluation of a solution where 100 points is a perfect score, and an output value of an evaluation function match each other. However, with conventional methods, the standards of an evaluation made by an evaluator are sometimes not consistent, and there are cases where scaling of the scoring and reference points of an evaluation differ for each evaluator when a plurality of evaluators are making an evaluation. Furthermore, the work of extracting the evaluation criteria for an evaluation target is sometimes performed using the perception of the evaluators, and it can be difficult to extract suitable evaluation criteria.

Due to the above, conventionally, it has been impossible to generate evaluation functions that accurately reproduce the evaluation results of solutions made by evaluators. Furthermore, when suitable evaluation criteria cannot be extracted, it is difficult to generate a suitable objective function, and a contradiction arises between the output of the generated evaluation function and the evaluations made by the evaluators.

### SUMMARY

Therefore, it is an object of an aspect of the innovations herein to provide an apparatus for assisting with the design of objective functions, which is capable of overcoming the above drawbacks accompanying the related art. The above and other objects can be achieved by combinations described in the claims. According to a first aspect of the present invention, provided is an apparatus comprising a processor and one or more computer readable mediums collectively including instructions that, when executed by the processor, cause the processor to: acquire learning data that includes an evaluation of evaluation targets; generate a constraint condition to be satisfied by a value of an evaluation function that includes a weighting for each of a plurality of evaluation criteria of the evaluation target and an unknown term for each evaluation target corresponding to an unknown evaluation criterion that is not among the plurality of evaluation criteria, based on the learning data; determine a value of the unknown term and the weighting for each evaluation criterion in the evaluation function in a manner that satisfies the constraint condition; extract a set of evaluation targets for which an evaluation of each evaluation criterion is opposite of an evaluation based on the unknown term, from among the plurality of evaluation targets; and output the extracted set of evaluation targets. Also provided is a method and computer-readable storage medium.

The summary clause does not necessarily describe all necessary features of the embodiments of the present invention. The present invention may also be a sub-combination of the features described above.

### BRIEF DESCRIPTION OF THE DRAWINGS

FIG. 1 is a block diagram of a generation apparatus 10 according to an embodiment of the present invention.

FIG. 2 shows examples of conventional evaluation targets and quantitative evaluations of the evaluation targets.

FIG. 3 shows exemplary qualitative evaluations according to the present embodiment.

FIG. 4 shows an exemplary process flow of the generation apparatus 10 according to the present embodiment.

FIG. 5 shows an exemplary scatter plot generated by the judging section 170.

FIG. 6 shows an exemplary scatter plot based on additional qualitative evaluations acquired by the acquiring section 110 according to the present embodiment.

FIG. 7 shows an exemplary configuration of the apparatus 200 according to the present embodiment.

FIG. 8 shows an exemplary process flow of the generation apparatus 10 according to the present embodiment.

FIG. 9 shows exemplary results obtained by simulating the operation of the apparatus 200 according to the present embodiment.

FIG. 10 shows an integer programming problem used by the extracting section 270 according to the present embodiment.

FIG. 11 shows an exemplary overview of first evaluation targets and second evaluation targets extracted by the extracting section 270 according to the present embodiment.

FIG. 12 shows an exemplary hardware configuration of a computer 1900 according to the embodiment of the invention.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

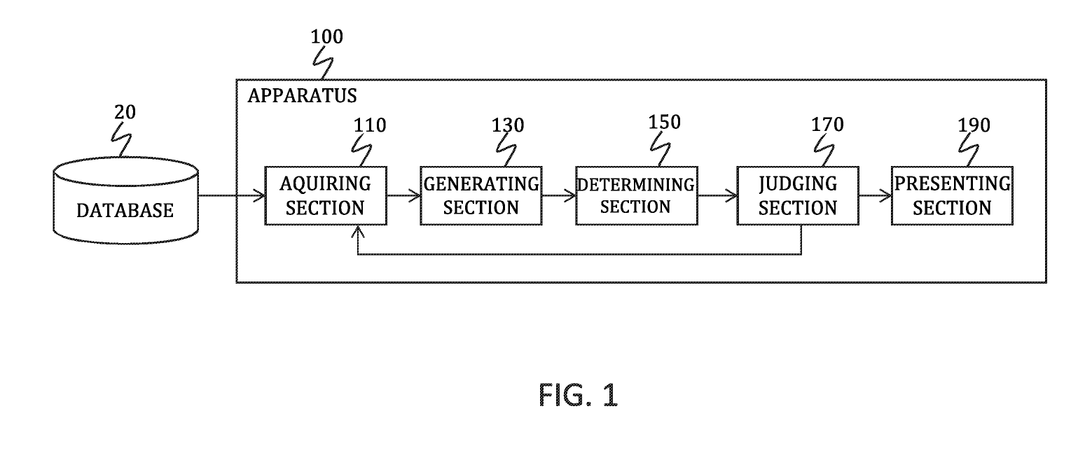

FIG. 1 is a block diagram of a generation apparatus 10 according to an embodiment of the present invention. The generation apparatus 10 may generate an evaluation function for calculating an evaluation value of an evaluation target. For example, the generation apparatus 10 generates an evaluation function that outputs an evaluation value indicating a quantitative evaluation of a solution in response to the input of a solution to an optimization problem. The generation apparatus 10 includes an acquiring section 110, a generating section 130, a determining section 150, a judging section 170, and a presenting section 190.

The acquiring section 110 may be operable to acquire learning data that includes an evaluation target and a qualitative evaluation of the evaluation target by an evaluator. For example, the acquiring section 110 acquires learning data that includes an evaluation target having a characteristic value for each characteristic, e.g. a characteristic value of 0.76 for the characteristic “filling rate,” from an external database 20 or the like and a qualitative evaluation, e.g. an evaluation of “evaluation target i is slightly better than evaluation target j,” having a comparison result obtained by an evaluating subject qualitatively compare two or more evaluation targets. The acquiring section 110 may supply the generating section 130 with the acquired learning data.

The generating section 130 may be operable to generate constraint conditions that are to be satisfied by the value of the evaluation function for an evaluation target, based on the learning data. For example, the generating section 130 generates, as a constraint condition, an inequation that includes the difference between evaluation values of the evaluation function for two or more evaluation targets being compared and evaluation threshold values serving as standards for qualitative evaluations. As another example, the generating section 130 generates a constraint condition based on an evaluation function that has a term based on the combined weighting of a plurality of basis functions into which a characteristic value is input for each characteristic of an evaluation target.

The generating section 130 may generate an objective function that has a plurality of variables, in which the output value is a target for optimization, e.g. minimization. For example, the generating section 130 generates an objective function that includes an error variable. The generating section 130 may generate an objective function that includes the total number of basis functions included in the evaluation function. Details of the constraint conditions and objective function generated by the generating section 130 are described further below. The generating section 130 may supply the determining section 150 with the generated constraint conditions and objective function.

The determining section 150 may be operable to determine a value of a variable in the objective function and a variable in the constraint conditions, in order to optimize the output value of the objective function while satisfying the constraint condition. For example, the determining section 150 determines a weighting for one or more characteristics in the evaluation function, a weighting for each of a plurality of basis functions, and an evaluation threshold value, in a manner to minimize the output value of the objective function while satisfying the constraint conditions generated by the generating section 130. The determining section 150 may supply the judging section 170 with the determined value of each variable.

The judging section 170 may be operable to calculate the difference between evaluation values of two or more evaluation targets by using the evaluation function based on the weighting determined by the determining section 150. The judging section 170 may be operable to judge whether the difference between calculated evaluation values is within a reference range relative to an evaluation threshold value determined by the determining section 150. The judging section 170 may supply the presenting section 190 with the judgment result.

The presenting section 190 may be operable to present an evaluating subject with a pair of evaluation targets for which the obtained difference between evaluation values is likely to be near the evaluation threshold value, if the judging section 170 indicates that the difference between evaluation values is within the reference range. For example, the presenting section 190 presents the evaluating subject with two or more evaluation targets for which the difference between the two or more evaluation values according to the current evaluation function is within the reference range.

If the judging section 170 makes a negative judgment, this is indicative of an evaluation threshold value for which there is no nearby data, and therefore it is possible that the accuracy of the evaluation threshold value is insufficient. Accordingly, data near the evaluation threshold value is preferably added in order to improve the accuracy of the evaluation threshold value. Here, the presenting section 190 may present the evaluating subject with an evaluation target for the purpose of acquiring data near the threshold value. In this way, the presenting section 190 can cause the acquiring section 110 to acquire a qualitative evaluation by an evaluating subject for the presented evaluation target, and cause the generation apparatus 10 to perform additional learning in order to improve the accuracy of the evaluation threshold value.

In this way, the generation apparatus 10 may acquire the learning data that includes a qualitative evaluation of a comparison result of evaluation targets by the evaluating subject and generate the constraint conditions and objective function based on the qualitative evaluation. The qualitative evaluation of the comparison results of the evaluation targets is an ordinal scale that indicates a ranking of the evaluation targets, and need not include a ratio scale such as scaling or reference points.

Accordingly, the generation apparatus 10 can generate the evaluation function with little variation resulting from an evaluation performed by the evaluating subject using a ratio scale, by solving the objective function with the constraint conditions generated based on the qualitative evaluation that is an ordinal scale. Furthermore, the generation apparatus 10 generates the evaluation function to have a term based on the total weighting of a plurality of basis functions into which a characteristic value is input for each characteristic of the evaluation target, and therefore it is possible to optimize the effect of the characteristic value of each characteristic on the evaluation value.

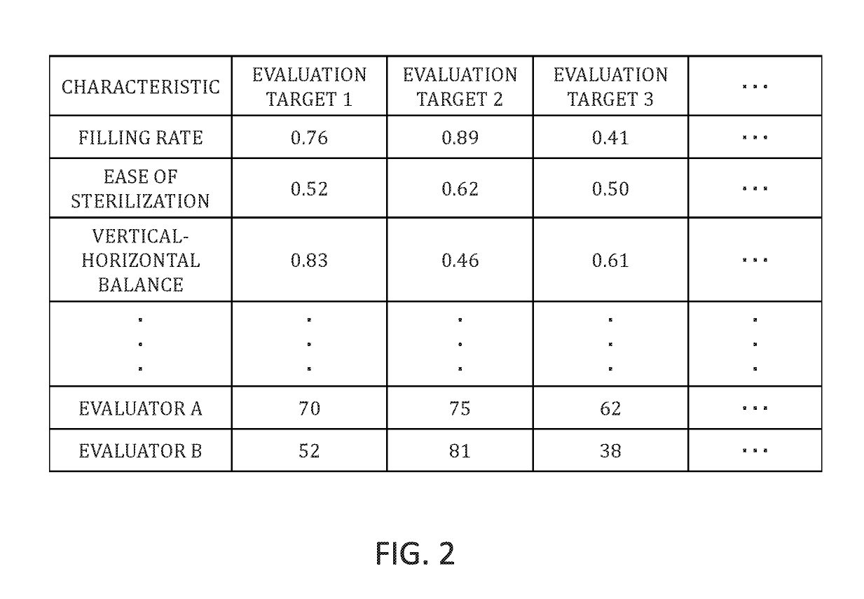

FIG. 2 shows examples of conventional evaluation targets and quantitative evaluations of the evaluation targets. The evaluation target 1, the evaluation target 2, the evaluation target 3, etc. shown in the table of FIG. 2 are different evaluation targets that are each targets for which the evaluation function outputs an evaluation value. Evaluation targets 1 to 3 etc. may be solutions obtained by having a solver solve an optimization problem, solutions generated by a person from an optimization problem, simulation results obtained by inputting initial conditions into a simulator, or the like.

Here, an example is shown in which the evaluation target is a method for packing medical equipment used for surgery or the like. For example, the medical equipment is preferably packed according to the type of surgery, the ease of extraction, the ease of storage, and/or ease of sterilization. The respective pieces of medical equipment are preferably packed in packages having limited types of size. Each piece of medical equipment is preferably packed to allow enough space in the package for the medical equipment to be quickly extracted from the package. Each piece of medical equipment preferably fills in its package without leaving excessive space in the package, and is preferably packed in a manner to use fewer packages.

An example is described in which, in order to pack this medical equipment, each piece of packed medical equipment is set as an evaluation target and each evaluation target is evaluated for each characteristic. Evaluation targets 1 to 3 are each evaluated according to characteristics such as “filling rate (does the piece of medical equipment sufficiently fill the space),” “ease of sterilization (is it easy for the package to be sterilized),” and “vertical-horizontal balance (does the package have good horizontal and vertical balance).”

As an example, for the evaluation target 1, the characteristic “filling rate” has a characteristic value of 0.76, the characteristic “ease of sterilization” has a characteristic value of 0.52, and the characteristic “vertical-horizontal balance” has a characteristic value of 0.83. As a result, an evaluator A acting as the evaluating subject may give the evaluation target 1 an evaluation of 70 points out of 100 points and an evaluator B may give the evaluation target 1 an evaluation of 52 points out of 100 points.

As an example, for the evaluation target 2, the characteristic “filling rate” has a characteristic value of 0.89, the characteristic “ease of sterilization” has a characteristic value of 0.62, and the characteristic “vertical-horizontal balance” has a characteristic value of 0.46. As a result, the evaluator A acting as the evaluating subject may give the evaluation target 2 an evaluation of 75 points out of 100 points and the evaluator B may give the evaluation target 2 an evaluation of 81 points out of 100 points.

As an example, for the evaluation target 3, the characteristic “filling rate” has a characteristic value of 0.41, the characteristic “ease of sterilization” has a characteristic value of 0.50, and the characteristic “vertical-horizontal balance” has a characteristic value of 0.61. As a result, the evaluator A acting as the evaluating subject may give the evaluation target 3 an evaluation of 62 points out of 100 points and the evaluator B may give the evaluation target 3 an evaluation of 38 points out of 100 points.

The quantitative evaluations of each evaluation target made by the evaluator A and the evaluator B may share the same trend. As a specific example, the evaluator A and the evaluator B both give the highest evaluation to the evaluation target 2, give the next highest evaluation to the evaluation target 1, and give the worst evaluation to the evaluation target 3.

However, the quantitative scores of the evaluations differ significantly between the evaluator A and the evaluator B. For example, the evaluation results of evaluation targets 1 to 3 made by the evaluator A have an average score of 69 points and a variance of 29 points, while the evaluation results of evaluation targets 1 to 3 made by the evaluator B have an average score of 57 points and a variance of 321 points. In this case, the evaluator A has a higher reference point and smaller scaling for the evaluation than the evaluator B (in other words, the evaluator A tends to give more forgiving evaluations and downplay problems).

Furthermore, there are cases where the same evaluator exhibits ambiguity in their evaluations when evaluating a plurality of evaluation targets. For example, if one evaluator is evaluating an extremely large number of evaluation targets, there are cases where the reference point and scale for the evaluation changes between the first and last evaluation. Due to this changing or shifting of the reference point and scale when utilizing a ratio scale, it has been difficult to accurately learn an evaluation function that reproduces evaluations of a plurality of evaluators from quantitative evaluations.

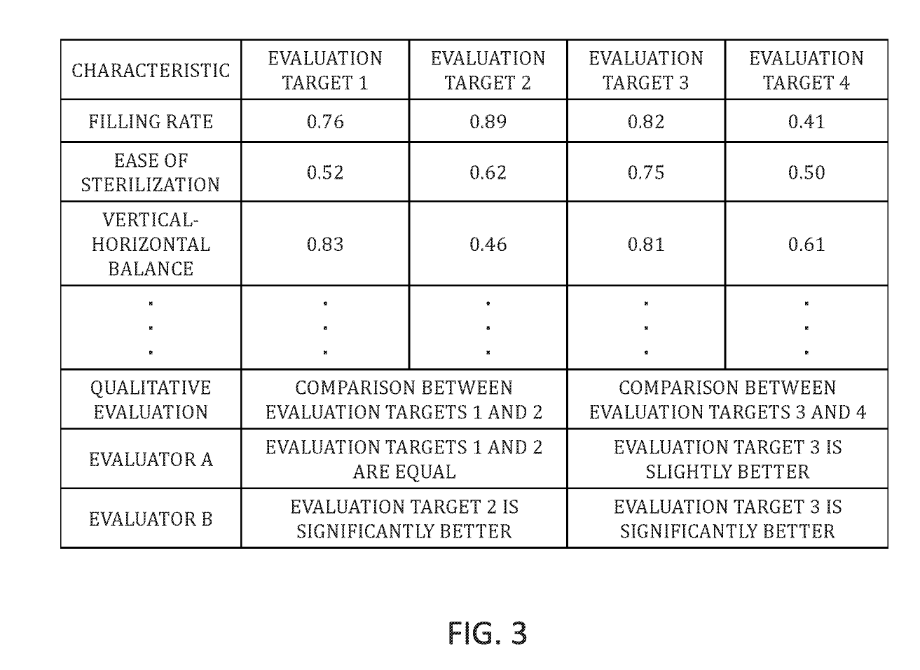

FIG. 3 shows exemplary qualitative evaluations according to the present embodiment. The acquiring section 110 of the present embodiment may acquire qualitative evaluations that include qualitative comparisons of a plurality of evaluation targets as the learning data, for the same evaluation targets as shown in FIG. 2. For example, instead of the quantitative evaluations shown in FIG. 2, the acquiring section 110 acquires a comparison result between the evaluation target 1 and the evaluation target 2 made by the evaluator A (indicating that the evaluation targets are equal), a comparison result between the evaluation target 3 and the evaluation target 4 made by the evaluator A (indicating that the evaluation target 3 is slightly better), a comparison result between the evaluation target 1 and the evaluation target 2 made by the evaluator B (indicating that the evaluation target 2 is significantly better), and a comparison result between the evaluation target 3 and the evaluation target 4 made by the evaluator B (indicating that the evaluation target 3 is significantly better).

As shown in FIG. 3, the evaluator A and the evaluator B may evaluate the evaluation targets using different standards. For example, the evaluator B tends to feel significant differences in the quality of the evaluation targets. However, the generating section 130 of the present embodiment generates a constraint condition that includes such differences among evaluators, and therefore it is possible to generate an evaluation function in which the effect caused by differences among evaluators is reduced.

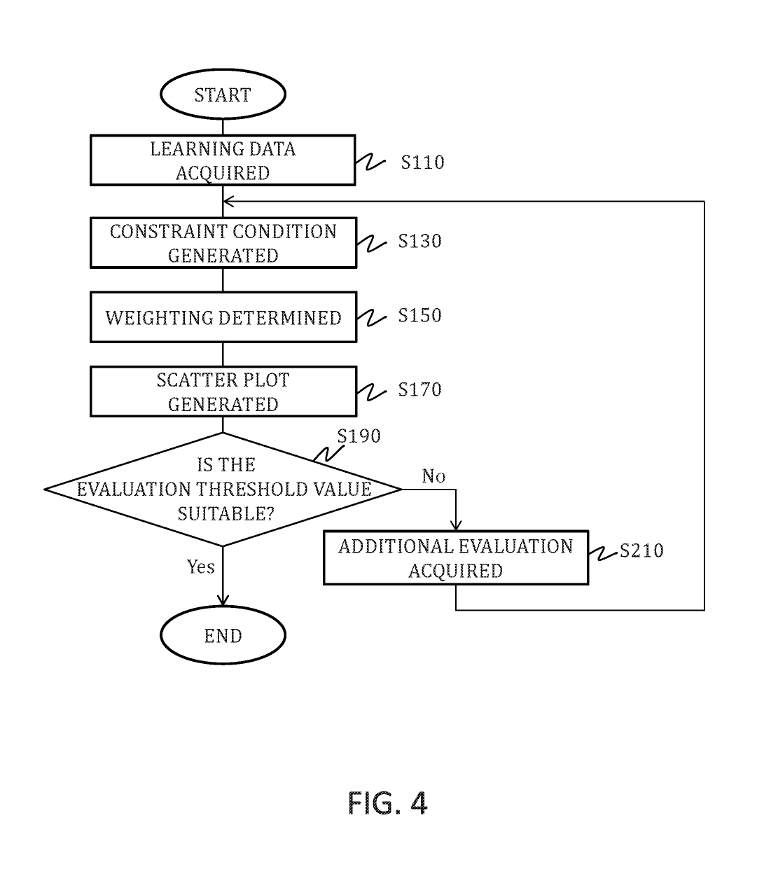

FIG. 4 shows an exemplary process flow of the generation apparatus 10 according to the present embodiment. In the present embodiment, the generation apparatus 10 may generate an evaluation function corresponding to the learning data by performing the processes from S110 to S210.

First, at S110, the acquiring section 110 may acquire the learning data for generating the evaluation function. For example, the acquiring section 110 acquires learning data that includes evaluation targets having characteristic values for each characteristic and qualitative evaluations of the evaluation targets made by an evaluating subject. The acquiring section 110 may acquire the learning data from a storage apparatus inside the generation apparatus 10, an external database 20 connected to the generation apparatus 10, and/or a network.

The acquiring section 110 may treat a solution to an optimization problem, a solution obtained from a simulation, a solution generated by a person, or the like as an evaluation target. The acquiring section 110 may treat a work method (e.g. a method of packing medical equipment), scheduling (e.g. a diagram of traffic or a method of manufacturing a product), actions in a game or competition (e.g. moves in chess), workplace strategies (e.g. opening of new franchise stores), and/or creative works (e.g. building designs or art pieces) as an evaluation target.

The acquiring section 110 may acquire a characteristic value for each characteristic of each evaluation target i as an evaluation target. For example, the acquiring section 110 acquires characteristic vectors x⁽ⁱ⁾=(xᵢ₁, xᵢ₂, . . . , x_{iK}) made up of K characteristics of the evaluation target i. As an example, the acquiring section 110 acquires integer values, binary values, or real number values representing the characteristics/features of the evaluation target as the characteristic values. The acquiring section 110 may acquire two or more characteristic values for one characteristic. For example, the acquiring section 110 may acquire a characteristic value including a plurality of characteristic values for each characteristic, and may acquire a vector obtained by linking together characteristic vectors as the evaluation target.

The acquiring section 110 may acquire, as a qualitative evaluation of an evaluation target, a qualitative evaluation including a comparison result obtained by the evaluating subject qualitatively comparing two or more evaluation targets. For example, the acquiring section 110 acquires a comparison result included in the learning data and a pair of evaluation targets that are the comparison targets and acquires, as the qualitative evaluation, results obtained by classifying the pair of evaluation targets according to the comparison results. The acquiring section 110 may acquire the comparison results of all pair combinations generated from all N evaluation targets (N×(N−1)×½). Instead, the acquiring section 110 may acquire, as the qualitative evaluation, results obtained by classifying a portion of all pair combinations.

The acquiring section 110 may acquire, as the qualitative evaluation, results obtained by performing classification according to the evaluation difference between pairs of evaluation targets based on a Likert scale. The acquiring section 110 may acquire each of a pair collection R₌^{(u)} including pairs classified as “the evaluation target i and the evaluation target j are equal,” a pair collection R_{>}^{(u)} including pairs classified as “the evaluation target i is slightly better than the evaluation target j,” and a pair collection R_{>>}^{(u)} including pairs classified as “the evaluation target i is significantly better than the evaluation target j.”

The acquiring section 110 may acquire, as the qualitative evaluation, results obtained by classifying the evaluation targets into three or more collections according to the types of comparison results. The acquiring section 110 may acquire, as the qualitative evaluation, a group collection R_{best} of a group A_{g} and the evaluation target i classified as “the evaluation target i is the best within the collection A_{g} made up of a plurality of evaluation targets including the evaluation target i,” or a group collection R_{worst} of a group A_{g} and the evaluation target i classified as “the evaluation target i is the worst within the collection A_{g} made up of a plurality of evaluation targets including the evaluation target i.”

Instead of or in addition to the qualitative evaluation based on the comparison results of a plurality of evaluation targets, the acquiring section 110 may acquire, as the qualitative evaluation, comparison results obtained from a qualitative comparison between the evaluation targets and predetermined evaluation standards. For example, the acquiring section 110 may acquire, as the qualitative evaluation, comparison results obtained by performing a qualitative comparison between each evaluation target and one or more evaluation standards. The acquiring section 110 may acquire, as the qualitative evaluation, comparison results (indicating equal/better/worse relative to an evaluation target serving as a model) obtained by comparing each evaluation target to an evaluation target serving as a model of a predetermined average evaluation, an evaluation target serving as a model of a predetermined bad evaluation, or an evaluation target serving as a model of a predetermined good evaluation.

The acquiring section 110 may acquire the qualitative evaluation made by one evaluating subject u (e.g. one evaluator). Instead, the acquiring section 110 may acquire learning data including a qualitative evaluation made by a plurality of evaluating subjects u (uεU). The acquiring section 110 may supply the generating section 130 with the acquired learning data.

Next, at step S130, the generating section 130 may generate constraint conditions to be satisfied by the value of the evaluation function for the evaluation target and the objective function that is the target of the optimization, based on the learning data.

For example, the generating section 130 generates, as a constraint condition, an inequation that includes the difference between evaluation values of the evaluation function for two or more evaluation targets being compared and evaluation threshold values serving as standards for qualitative evaluations. As an example, for each pair (the evaluation target i and the evaluation target j) in the pair collection R₌^{(u)} indicating that “the evaluation target i and the evaluation target j are equal” in the learning data, the generating section 130 generates an inequation such that the absolute value of a value obtained by adding an error variable σᵢⱼ corresponding to the pair of the evaluation target i and the evaluation target j to the difference between an evaluation value f_{w}(x⁽ⁱ⁾) of the evaluation function for the evaluation target i and an evaluation value f_{w}(x^{(j)}) of the evaluation function for the evaluation target j is less than or equal to a first evaluation threshold value zᵤ₀. For example, the generating section 130 generates the inequation shown in Expression 1.

−zᵤ₀≦f_{w}(x⁽ⁱ⁾)−f_{w}(x^{(j)})+σᵢⱼ≦zᵤ₀ for each (i,j)εR_{≈}^{(u)} for each uεU Expression 1:

As another example, for each pair (the evaluation target i and the evaluation target j) in the pair collection R_{>}^{(u)} indicating that “the evaluation target i is slightly better than the evaluation target j” in the learning data, the generating section 130 generates an inequation such that the absolute value of a value obtained by adding an error variable σᵢⱼ corresponding to the pair of the evaluation target i and the evaluation target j to the difference between an evaluation value f_{w}(x⁽ⁱ⁾) of the evaluation function for the evaluation target i and an evaluation value f_{w}(x^{(j)}) of the evaluation function for the evaluation target j is greater than or equal to the first evaluation threshold value zᵤ₀ and less than or equal to a second evaluation threshold value zᵤ₁. For example, the generating section 130 generates the inequation shown in Expression 2.

zᵤ₀≦f_{w}(x⁽ⁱ⁾)−f_{w}(x^{(j)})+σᵢⱼ≦zᵤ₁ for each (i,j)εR_{>}^{(u)} for each uεU Expression 2:

As another example, for each pair (the evaluation target i and the evaluation target j) in the pair collection R_{>>}^{(u)} indicating that “the evaluation target i is significantly better than the evaluation target j” in the learning data, the generating section 130 generates an inequation such that the absolute value of a value obtained by adding an error variable σᵢⱼ corresponding to the pair of the evaluation target i and the evaluation target j to the difference between an evaluation value f_{w}(x⁽ⁱ⁾) of the evaluation function for the evaluation target i and an evaluation value f_{w}(x^{(j)}) of the evaluation function for the evaluation target j is greater than or equal to the second evaluation threshold value zᵤ₁. For example, the generating section 130 generates the inequation shown in Expression 3.

zᵤ₁≦f_{w}(x⁽ⁱ⁾)−f_{w}(x^{(j)})+σᵢⱼ for each (i,j)εR_{>>}^{(u)} for each uεU Expression 3:

As another example, the generating section 130 generates the constraint condition from each group in the group collection R_{best} indicating that “the evaluation target i is the best within the group A_{g} made up of a plurality of evaluation targets including the evaluation target i” in the learning data. For example, for each of the plurality of pairs of an evaluation target i and an evaluation target j that is not the evaluation target i that can be generated from a group, the generating section 130 generates an inequation such that the absolute value of a value obtained by adding an error variable σᵢⱼ corresponding to the pair of the evaluation target i and the evaluation target j to the difference between an evaluation value f_{w}(x⁽ⁱ⁾) of the evaluation function for the evaluation target i and an evaluation value f_{w}(x^{(j)}) of the evaluation function for the evaluation target j is greater than or equal to zero. For example, the generating section 130 generates the inequation shown in Expression 4.

f_{w}(x⁽ⁱ⁾)−f_{w}(x^{(j)})+σᵢⱼ≧0 for each {(i,j)|jεA_{g},(i,A_{g})εR_{best}} Expression 4:

As another example, the generating section 130 generates the constraint condition from each group in the group collection R_{worst} indicating that “the evaluation target i is the worst within the group A_{g} made up of a plurality of evaluation targets including the evaluation target i” in the learning data. For example, for each of the plurality of pairs of an evaluation target i and an evaluation target j that is not the evaluation target i that can be generated from a group, the generating section 130 generates an inequation such that the absolute value of a value obtained by adding an error variable σᵢⱼ corresponding to the pair of the evaluation target i and the evaluation target j to the difference between an evaluation value f_{w}(x⁽ⁱ⁾) of the evaluation function for the evaluation target i and an evaluation value f_{w}(x^{(j)}) of the evaluation function for the evaluation target j is less than or equal to zero. For example, the generating section 130 generates the inequation shown in Expression 5.

f_{w}(x⁽ⁱ⁾)−f_{w}(x^{(j)})+σᵢⱼ≦0 for each {(i,j)|jεA_{g},(i,A_{g})εR_{worst}} Expression 5:

If a qualitative evaluation for each evaluating subject u (uεU) is acquired as the learning data, the generating section 130 may generate, as the constraint condition, an inequation that includes an evaluation threshold value for each evaluating subject u (uεU). The generating section 130 may generate the inequations shown in Expressions 1 to 5 for each evaluating subject. Instead, the generating section 130 may generate the inequations shown in Expressions 1 to 5 in common for all of the evaluating subjects.

The generating section 130 generates the constraint conditions for the evaluation function. For example, the generating section 130 generates a constraint condition based on the evaluation function f_{w}(x) that includes the term wₖₗφₖₗ(xₖ), which is based on the total weighting of the Mₖ (l and Mₖ are integers and satisfy 1≦l≦Mₖ) types of basis functions φₖₗ(xₖ) in which a characteristic value xₖ is input for each characteristic k (kεK) of the evaluation target.

The generating section 130 may use various functions as the Mₖ types of basis functions φₖₗ(x). The generating section 130 may use ax+b, a(x−b)²+c, a(x−b)^{1/2}+c, a/(x−b)+c, a·exp(−b(x−c)²)+d, a/(b+c·exp(d(x−e))), or the like as the basis function φₖₗ(xₖ). Here, a, b, c, d, and e may be predetermined constants. The generating section 130 may use basis functions φₖₗ(xₖ) of the same type but having different constants (e.g. x+5 and 2x−5).

As an example, the generating section 130 generates the constraint condition shown in Expression 6. In this way, the generating section 130 may define the evaluation function.

$${f}_{w} ( x ) ≡ {\sum }_{1 \leq k \leq K} {\sum }_{1 \leq l \leq {M}_{k}} {w}_{ld} {φ}_{ld} ( {x}_{k} ) \qquad Expression 6$$

The generating section 130 may generate the constraint condition for the total weighting wₖₗ for all types lεMₖ of basis functions of all characteristics kεK. For example, the generating section 130 generates the constraint condition setting the total weighting wₖₗ to a value of 1. In other words, the generating section 130 generates the constraint condition shown in Expression 7.

$${\sum }_{1 \leq k \leq K} {\sum }_{1 \leq l \leq {M}_{k}} {w}_{ld} = 1 \qquad Expression 7$$

The generating section 130 may generate a constraint condition relating to a selection variable yₖₗ of the basis function and the weighting wₖₗ. For example, the generating section 130 generates the constraint condition such that the weighting wₖₗ is greater than or equal to 0 and less than or equal to the selection variable yₖₗ. Furthermore, the generating section 130 may generate the constraint condition such that the selection variable yₖₗ of the basis function can have only a value of either 0 or 1.

In this way, if the selection variable yₖₗ of the basis function has a value of 1, the weighting of the basis function φₖₗ(x) corresponding to the evaluation function has a value greater than 0. Accordingly, it is allowable for the basis function φₖₗ(x) to be adopted in the evaluation function. On the other hand, if the selection variable yₖₗ of the basis function has a value of 0, it is not allowable for the basis function φₖₗ(x) to be adopted in the evaluation function until the weighting of the basis function φₖₗ(x) corresponding to the evaluation function has reached a value of 0.

In other words, the selection variable yₖₗ may determine whether the basis function φₖₗ(x) is adopted in the evaluation function f_{w}(x). In this way, the generating section 130 may generate a constraint condition including the selection variable yₖₗ that indicates whether each of a plurality of basis functions φₖₗ(x) is included. For example, the generating section 130 generates the constraint conditions shown in Expression 8 and Expression 9.

0≦w_{ld}≦y_{ld} for each {(k,l)|l≦k≦K, 1≦l≦Mₖ} Expression 8:

y_{ld}ε{0,1} for each {(k,l)|l≦k≦K, 1≦l≦Mₖ} Expression 9:

The generating section 130 may generate a constraint condition limiting the number of basis functions φₖₗ(x) that can be adopted for each characteristic (kεK) in the evaluation function. The generating section 130 may generate a constraint condition setting the total number of types of basis functions φₖₗ(x) used in the terms corresponding to the characteristics k of the evaluation function to be less than or equal to a predetermined number Bₖ. In this way, the generating section 130 can prevent overfitting of the evaluation function in learning data. The generating section 130 may generate the constraint condition shown in Expression 10. Here, Bₖ is a predetermined integer representing a maximum number of basis functions.

$${\sum }_{1 \leq k \leq K} {y}_{ld} \leq {B}_{k} for each 1 \leq k \leq K \qquad Expression 10$$

The generating section 130 may generate a constraint condition such that the total weighting of the basis functions φₖₗ(x) that can be adopted for each characteristic k (kεK) in the evaluation function is greater than or equal to a predetermined standard Wₖ. In this way, the generating section 130 can prevent the evaluation function from completely ignoring a portion of the characteristics of the evaluation target. For example, the generating section 130 may generate the constraint condition shown in Expression 11.

$${\sum }_{1 \leq l \leq {M}_{k}} {w}_{ld} \leq {W}_{k} for each 1 \leq k \leq K \qquad Expression 11$$

The generating section 130 may generate all of the constraint conditions shown in Expression 1 to Expression 11, or may omit a portion of these constraint conditions. The generating section 130 may omit the constraint conditions corresponding to either Expressions 2 and 3 or Expressions 4 and 5, and/or may omit the constraint conditions corresponding to at least some of Expressions 8 to 11.

The generating section 130 may generate the objective function together with the constraint conditions. The generating section 130 generates the objective function including the total sum of the absolute values of the error variables σᵢⱼ included in the inequations relating to the evaluation threshold values. As an example, the generating section 130 may also add the total sum of the selection variables yₖₗ to the objective function. If the total sum of the selection variables yₖₗ is added to the objective function, fewer types of basis functions φₖₗ(x) are adopted in the evaluation function, and therefore it is possible to prevent overfitting of the evaluation function in the learning data. As an example, the generating section 130 generates the objective function according to Expression 12.

$${min}_{w , y} {\sum }_{( i , j ) ∈ R} \vert {σ}_{ij} \vert + {λ}_{y} {\sum }_{1 \leq k \leq K} {\sum }_{1 \leq l \leq {M}_{k}} {y}_{kl} \qquad Expression 12$$

Here, λ_{y} is a predetermined constant (e.g. 1) and determines the balance between the total sum of the error variables σᵢⱼ and the total sum of the selection variables yₖₗ in the evaluation function. The generating section 130 may optimize λ_{y} using cross-validation after fixing the variables such as the error variables σᵢⱼ.

The generating section 130 may supply the determining section 150 with the generated constraint conditions and objective function.

Next, at S150, the determining section 150 may optimize the value of each variable including a weighting using the objective function containing the error variables and/or the total number of basis functions included in the evaluation function. For example, the determining section 150 determines the weighting wₖₗ and the evaluation threshold values zᵤ₀ and zᵤ₁ of each of the plurality of basis functions for one or more characteristics in the evaluation function, in a manner to optimize the output value of the objective function while satisfying the constraint conditions generated at S130.

As an example, the determining section 150 determines the error variables σᵢⱼ of the evaluation targets i and j for each pair and each group of evaluation targets, the weighting wₖₗ and the selection variable yₖₗ for each characteristic k and each basis function 1, and each evaluation threshold value zᵤ₀ and zᵤ₁ for each evaluating subject u in a manner to minimize the objective function of Expression 12 while maintaining the constraint conditions of Expressions 1 to 11.

The optimization of an objective function having constraint conditions is a mixed integer programming (MIP) problem, and therefore the determining section 150 can perform the process of S150 using an existing solver (e.g. IBM ILOG CPLEX). If constraint conditions utilizing the selection variables yₖₗ are omitted, the determining section 150 can easily perform the process of S150 by solving a linear programming (LP) problem. The determining section 150 may supply the judging section 170 with each determined variable value.

Next, at S170, the judging section 170 may generate a scatter plot from two or more evaluation targets in the learning data, based on the evaluation function that is based on the variables such as the determined weighting. For example, the judging section 170 inputs the characteristic values of a plurality of pairs of evaluation targets (i.e. the pairs included in the pair collection R₌^{(u)}, the pair collection R_{>}^{(u)}, and the pair collection R_{>>}^{(u)}) in the learning data acquired from the comparison results at S110 into the evaluation function determined at S150 and obtain evaluation values of the evaluation targets in the pairs. The judging section 170 may then generate the scatter plot with the differences between evaluation values of a pair plotted on the horizontal axis.

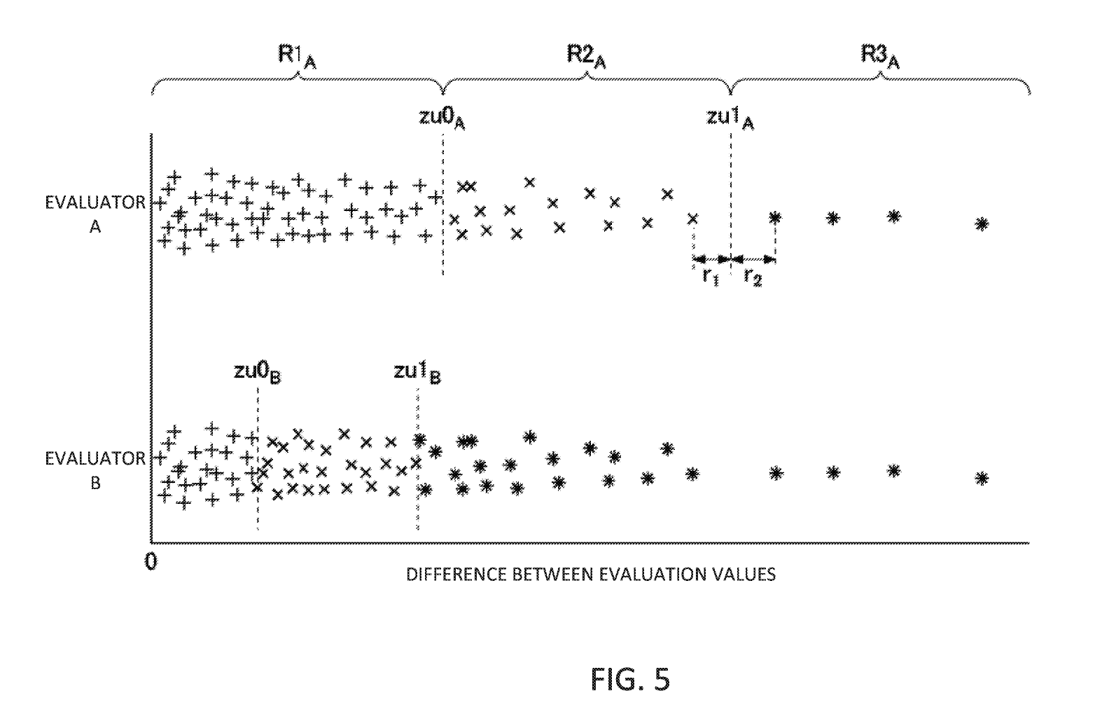

FIG. 5 shows an exemplary scatter plot generated by the judging section 170. FIG. 5 shows an example of results obtained by two evaluators, i.e. the evaluator A and the evaluator B, evaluating the same plurality of pairs of evaluation targets. The judging section 170 may generate the scatter plot obtained by a plurality of evaluators evaluating different pairs of evaluation targets. In this graph, the + marks correspond to pairs of evaluation targets for which the evaluator A or the evaluator B has judged the evaluation targets to be equal, the X marks correspond to pairs of evaluation targets for which the evaluator A or the evaluator B has judged one of the evaluation targets to be slightly better, and the * marks correspond to pairs of evaluation targets for which the evaluator A or the evaluator B has judged one of the evaluation targets to be significantly better. In the graph, R1_{A} indicates the pair collection of evaluation target pairs judged to be “equal” by the evaluator A, R2_{A} indicates the pair collection of evaluation target pairs that have received a judgment of “one is slightly better” from the evaluator A, and R3_{A} indicates the pair collection of evaluation target pairs that have received a judgment of “one is significantly better” from the evaluator A.

Here, z_{u0A} indicates the first evaluation threshold value separating R1_{A} from R2_{A}, z_{u1A} indicates the second evaluation threshold value separating R2_{A} from R3_{A}, z_{u0B} indicates the first evaluation threshold value of the evaluator B, and z_{u1B} indicates the second evaluation threshold value of the evaluator B. As shown in the diagram, the evaluator A has a greater first evaluation threshold value and second evaluation threshold value than the evaluator B. In other words, a difference is evaluated by the evaluator A, and therefore a greater evaluation difference is needed for evaluations by the evaluator A than for evaluations by the evaluator B.

Next, at S190, the judging section 170 may judge whether the evaluation threshold values determined at S150 are suitable. For example, the judging section 170 judges whether the difference values between the evaluation values in the scatter plot generated at S170 are within a reference range relative to the evaluation threshold values. As an example, the second evaluation threshold value z_{u1A} of the evaluator A in FIG. 5 is distanced from the two closest evaluation values by a distance r₁ and a distance r₂ respectively, and it is determined of one of the greater or smaller values among the distance r₁ and the distance r₂ or the total of these distances is greater than or equal to a predetermined standard.

The distance between an evaluation threshold value and the evaluation value closest to this evaluation threshold value relates to the accuracy of this evaluation threshold value. If this distance is large, it means that the determining section 150 has determined the evaluation threshold value without there being data near the evaluation threshold value, and therefore the reliability of the determined evaluation threshold value tends to be lower. Accordingly, the judging section 170 may judge whether the accuracy of the evaluation threshold value is sufficient in the process of S190.

The judging section 170 may end the processing if it is judged that the distance is within a reference range. For example, if it is judged that the distance is within the reference range, the judging section 170 may supply the presenting section 190 with the judgment result and then end the processing.

At S210, the acquiring section 110 may acquire additional qualitative evaluations and add these evaluations to the learning data, in response to a difference between evaluation values being judged as not being within the reference range for an evaluation threshold value. For example, if the judgment result indicates that a difference between evaluation values is not within the reference range, the presenting section 190 presents the evaluating subject with a pair or group of evaluation targets corresponding to a region near the evaluation threshold value. As an example, the presenting section 190 presents the evaluating subject handling this evaluation threshold value with two or more evaluation targets for which the difference between evaluation values of the two or more evaluation targets according to the current evaluation function is expected to be within the reference range for this evaluation threshold value.

After the presentation by the presenting section 190, the acquiring section 110 may acquire the additional qualitative evaluation obtained by the evaluating subject evaluating the two or more evaluation targets that were presented. For example, the presenting section 190 presents the evaluator A with two pairs of evaluation targets for which it is expected that the differences between evaluation values will be near the second evaluation threshold value z_{u1A} of the evaluator A, and these evaluation value differences n₁ and n₂ are acquired as qualitative evaluations.

The acquiring section 110 may add the acquired additional qualitative evaluations to the learning data. In this case, the generation apparatus 10 returns the processing to S130. The generating section 130 may then generate the constraint conditions again based on the learning data to which the qualitative evaluations have been added, and the determining section 150 may generate the evaluation function.

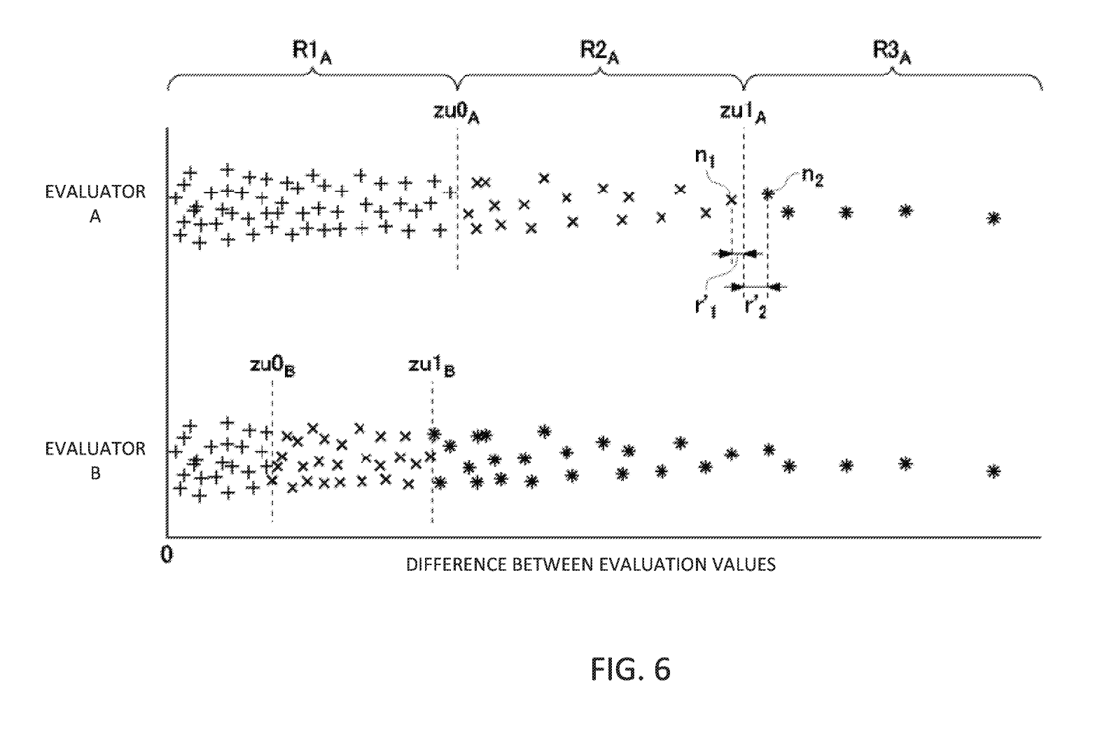

FIG. 6 shows an exemplary scatter plot obtained using the evaluation function generated based on additionally acquired qualitative evaluations. As shown in the drawing, the evaluation value differences n₁ and n₂ corresponding to the additional qualitative evaluations appear near the second evaluation threshold value z_{u1A}. Here, the respective distances r′₁ and r′₂ of the evaluation value differences n₁ and n₂ from the second evaluation threshold value z_{u1A} are each shorter than the shortest distances r₁ and r₂ of the evaluation value differences from this evaluation threshold value before the additional qualitative evaluations were acquired. Accordingly, it is shown that by using the additional qualitative evaluations, the generation apparatus 10 acquires a more accurate second evaluation threshold value z_{u1A}.

In this way, the generation apparatus 10 solves the objective function having constraint conditions generated based on the qualitative evaluations of comparison results of evaluation targets made by the evaluating subject. The qualitative evaluations of the comparison results use an ordinal scale, and therefore are more consistent and less varied than quantitative evaluations that use a ratio scale. Accordingly, the generation apparatus 10 can generate the evaluation function in which the effect of errors caused by the variance of the evaluation standards of the evaluating subjects is reduced.

The generation apparatus 10 may generate constraint conditions that have different evaluation threshold values set for each evaluating subject, while providing a common weighting for all evaluating subjects in the evaluation function. In this way, it is possible to generate the evaluation function in common for a plurality of evaluating subjects, while handling the differences in comparison standards among the plurality of evaluating subjects.

The generation apparatus 10 may generate the evaluation function having a term based on the total weighting of a plurality of basis functions that have a characteristic value input for each of one or more characteristics of the evaluation targets. In other words, the generation apparatus 10 generates the evaluation function in which suitable basis functions have been selected in accordance with the characteristic features, and therefore it is possible to optimize the effect of the characteristic values on the evaluation values.

In the above example, the acquiring section 110 acquires the learning data that includes qualitative evaluations with three stages (equal, slightly better, and significantly better) and the generating section 130 generates the constraint condition including an inequation that has evaluation threshold values forming three stages, but the acquiring section 110 may acquire the learning data that includes qualitative evaluations with one, two, or four or more stages and the generating section 130 may generate constraint conditions including an inequation that has evaluation threshold values forming one, two, or four or more stages.

Furthermore, instead of or in addition to the learning data including qualitative evaluations obtained by comparing two evaluation targets (equal, one is slightly better, one is significantly better), the acquiring section 110 may acquire the learning data including qualitative evaluations obtained by comparing a difference of a qualitative evaluation between two evaluation targets and a difference of a qualitative evaluation between another two evaluation targets. For example, the acquiring section 110 may acquire the learning data including a qualitative evaluation such as “the difference between the evaluation target i₁ and the evaluation target i₂ is equal to/slightly greater than/significantly greater than the difference between the evaluation target i₃ and the evaluation target i₄.” In this case, the generating section 130 may generate corresponding constraint conditions (e.g. −zᵤ₀≦|f_{w}(x⁽ⁱ¹⁾)−f_{w}(x⁽ⁱ²⁾|−|f_{w}(x⁽ⁱ³⁾)−f_{w}(x⁽ⁱ⁴⁾)|≦zᵤ₀).

The above description of the present embodiment is an example in which the generation apparatus 10 acquires qualitative evaluations of a plurality of evaluation targets and generates the constraint conditions. Instead of or in addition to this, the generation apparatus 10 may acquire qualitative evaluations of feature differences among a plurality of evaluation targets and generate the constraint conditions. For example, the generating section 130 acquires qualitative evaluations for feature differences between pairs of evaluation targets from the evaluating subjects (e.g. “the evaluation target i and the evaluation target j have completely different features” and “the evaluation target i and the evaluation target j have similar features”) and generate characteristic vectors from the characteristic values of each evaluation target. The generating section 130 may generate the constraint conditions including inequations based on Euclidean distances of the characteristic vectors of evaluation targets in pairs and the acquired qualitative evaluations.

In the manner described above, the generation apparatus 10 according to the present embodiment can generate the objective function having constraint conditions that can be solved by a solver, based on the qualitative evaluations of comparison results between evaluation targets made by evaluating subjects. The evaluating subjects are preferably made up of experts who are knowledgeable about the evaluation targets. For example, if the packing of medical equipment is being optimized, the evaluating subjects may be surgical doctors, packing workers, and/or employees of medical equipment manufacturers. In this way, variation in the evaluations made by the evaluating subjects can be reduced.

However, the generation apparatus 10 generates the objective function based on the characteristic value of each of the characteristics, which are evaluation criteria, and therefore there has been a problem that a suitable objective function cannot be generated depending on the design or the setting of the evaluation criteria. For example, by getting opinions from an expert or the like and extracting characteristics such as “filling rate,” “ease of sterilization,” and “vertical-horizontal balance,” the generation apparatus 10 can generate the objective function and constraint conditions based on the characteristic value of each of these characteristics. However, if a characteristic of “surface area of the bottom surface” is left out from the evaluation criteria, for example, the calculated solution might not be the optimal solution for an expert.

For example, regardless of the evaluation result based on the evaluation function generated by the generation apparatus 10 indicating that one evaluation target has a higher evaluation value than another evaluation target, there are cases where the other evaluation target is evaluated more highly when the one evaluation target and the other evaluation target are presented to an expert. Accordingly, in order to prevent contradictions between the evaluation result of the generation apparatus 10 and the evaluation result of an evaluating subject, suitable evaluation criteria are preferably extracted.

However, even after getting opinions from experts or the like, it is difficult to extract latent evaluation criteria such as items that are obvious to an expert or items that experts are not particularly conscious of. Accordingly, even when the generation apparatus 10 according to the present invention is used, it can be difficult to generate a suitable objective function. Therefore, an apparatus 200 according to an embodiment of the present invention elicits latent evaluation criteria based on the evaluation results of the evaluating subjects. This apparatus 200 is described below.

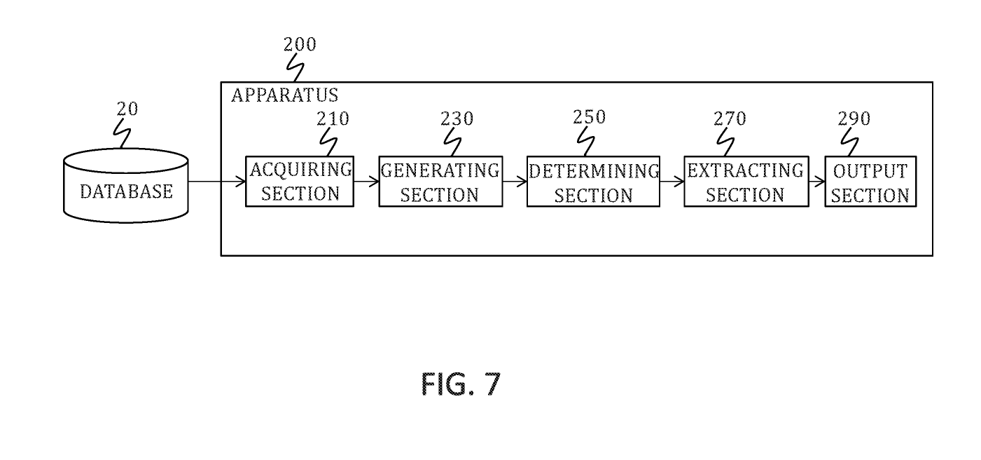

FIG. 7 shows an exemplary configuration of the apparatus 200 according to the present embodiment. The apparatus 200 includes an acquiring section 210, a generating section 230, a determining section 250, an extracting section 270, and an output section 290.

The acquiring section 210 may be operable to acquire the learning data including evaluations of evaluation targets. The acquiring section 210 may perform the same operation as the acquiring section 110 of the generation apparatus 100 according to the embodiment described in FIG. 1. In other words, the acquiring section 210 may acquire the learning data including, as the evaluations, qualitative evaluations that are comparison results obtained by qualitatively comparing two or more evaluation targets. The acquiring section 210 may acquire the learning data that further includes, as evaluations, comparison results obtained by qualitatively comparing evaluation targets to a predetermined evaluation standard. The acquiring section 210 may acquire the learning data form an external database 20 or the like. The acquiring section 210 may supply the generating section 230 with the acquired learning data.

The generating section 230 may be operable to generate constraint conditions that are to be satisfied by the value of the evaluation function for an evaluation target, based on the learning data. The generating section 230 may be operable to, based on the learning data, generate the constraint conditions that are to be satisfied by the value of the evaluation function including a weighting for each of a plurality of evaluation criteria of the evaluation targets and an unknown term for each evaluation criterion corresponding to an unknown evaluation criterion that is not among the plurality of evaluation criteria. The generating section 230 may generate the constraint conditions based on the evaluation function having an unknown term and a term based on the total weighting of a plurality of basis functions into which a characteristic value is input for each evaluation criterion of the evaluation targets. For example, the generating section 230 generates, as a constraint condition, an inequation that includes the difference between evaluation values of the evaluation function for two or more evaluation targets being compared and evaluation threshold values serving as standards for qualitative evaluations.

The generating section 230 may perform the same operation as the generating section 130 of the generation apparatus 100 according to the embodiment described in FIG. 1 for a plurality of evaluation criteria (i.e. characteristics) of the evaluation targets. For example, the generating section 230 generates an objective function that includes an error variable. The details of the constraint conditions and objective function generated by the generating section 230 are described further below. The generating section 230 supplies the determining section 250 with the generated constraint conditions and objective function.

The determining section 250 may be operable to determine a value of an unknown term and the weighting for each evaluation criterion in the evaluation function, in a manner to satisfy the constraint conditions. For example, the determining section 250 may determine a weighting for one or more evaluation criteria in the evaluation function, a weighting for each of a plurality of basis functions, an evaluation threshold value, and a value of the unknown term, in a manner to minimize the output value of the objective function while satisfying the constraint conditions generated by the generating section 230. The determining section 250 may supply the extracting section 270 with the value of each decision variable.

The extracting section 270 may be operable to extract a set of evaluation targets whose evaluations made for each evaluation criterion are the opposite of the evaluations based on the unknown term, from among the plurality of evaluation targets. For example, the extracting section 270 extracts, from among the plurality of evaluation targets, a set including a first evaluation target and a second evaluation target that has lower characteristic values than the first evaluation target for all evaluation criteria but has a higher evaluation than the first evaluation target for the evaluation based on the unknown term. In other words, the extracting section 270 extracts the first evaluation target and the second evaluation target such that the second evaluation target has a lower evaluation than the first evaluation target for all evaluation criteria but, when referencing the unknown term, has a higher evaluation than the first evaluation target for the evaluation corresponding to the unknown term. The extracting section 270 may supply the output section 290 with the extracted set of the first evaluation target and the second evaluation target.

The output section 290 may be operable to output the extracted set of evaluation targets. The output section 290 may output the extracted set of evaluation targets to a user. In this way, the output section 290 can present the evaluating subject with the set of the first evaluation target and the second evaluation target. Therefore, the evaluating subject can compare the second evaluation target to the first evaluation target to confirm that the second evaluation target has lower values than the first evaluation target for all known evaluation criteria and a higher value than the first evaluation target for the evaluation of the unknown term. In this way, the evaluating subject easily sees the new evaluation criteria corresponding to the unknown term. In other words, the apparatus 200 can elicit latent evaluation criteria. The following describes the process flow performed by this apparatus 200.

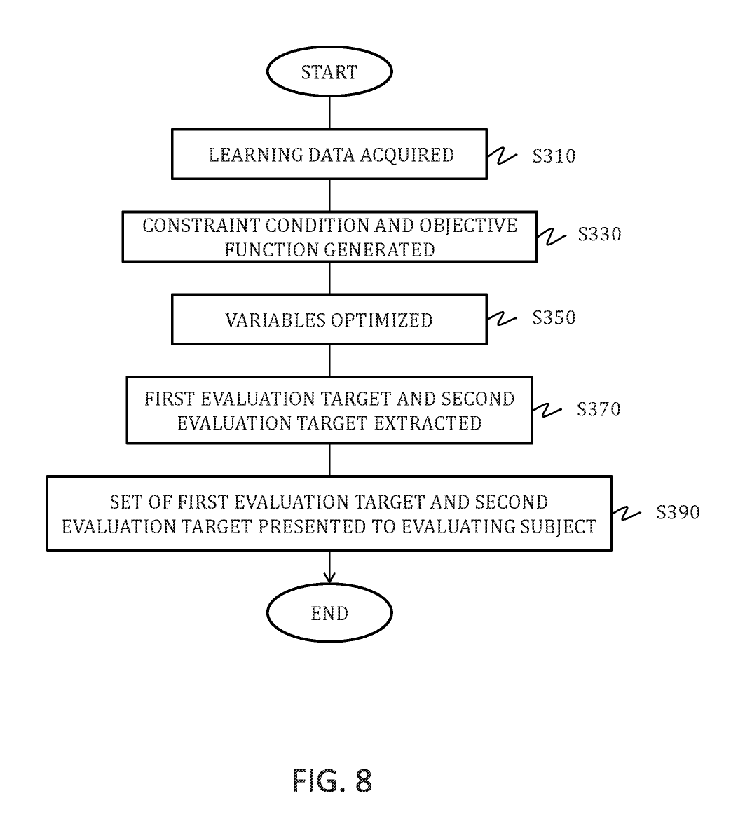

FIG. 8 shows an exemplary process flow of the apparatus 200 according to the present embodiment. In the present embodiment, by performing the processes from S310 to S390, the apparatus 200 extracts the set of the first evaluation target and the second evaluation target corresponding to the learning data and presents the extracted set to the evaluating subject.

First, at S310, the acquiring section 210 may acquire the learning data for generating the evaluation function. For example, the acquiring section 210 acquires the learning data including evaluation targets having a characteristic value for each characteristic and qualitative evaluations of the evaluation targets by evaluating subjects. The acquiring section 210 may acquire the learning data from a storage apparatus inside the apparatus 200, an external database 20 connected to the apparatus 200, a network, and/or the like.

The acquiring section 210 may perform the same operation as the acquiring section 110 of the generation apparatus 100 according to the embodiment described in FIG. 4. For example, the acquiring section 210 acquires a characteristic value of each characteristic of each evaluation target i, as the evaluation target. The acquiring section 210 may acquire characteristic vectors x⁽ⁱ⁾=(xᵢ₁, xᵢ₂, . . . , x_{iK}) made up of K characteristics of the evaluation target i. As an example, the acquiring section 210 acquires integer values, binary values, or real number values representing the characteristics/features of the evaluation target as the characteristic values. The acquiring section 210 may acquire two or more characteristic values for one characteristic. For example, the acquiring section 210 may acquire a characteristic value including a plurality of characteristic values for each characteristic, and may acquire a vector obtained by linking together characteristic vectors as the evaluation target.

The acquiring section 210 may acquire, as a qualitative evaluation of an evaluation target, a qualitative evaluation including a comparison result obtained by the evaluating subject qualitatively comparing two or more evaluation targets. For example, the acquiring section 210 may acquire a comparison result included in the learning data and a pair of evaluation targets that are the comparison targets and acquire, as the qualitative evaluation, results obtained by classifying the pair of evaluation targets according to the comparison results. The acquiring section 210 may acquire, as the qualitative evaluation, results classified according to the evaluation difference for a pair of evaluation targets, based on a Likert scale.

Next, at S330, the generating section 230 may generate the constraint conditions to be satisfied by the value of the evaluation function for the evaluation targets and the objective function that is the optimization target, based on the learning data. For example, using a decision variable ex, the generating section 230 can newly define the evaluation function based on Expression 6 as shown in Expression 13 below.

f_{w}′(x⁽ⁱ⁾)≡f_{w}(x⁽ⁱ⁾)+ωᵢ Expression 13:

Expression 13 includes the decision variable ωᵢ corresponding to the unknown evaluation criterion, and corresponds to a predictive model. The generating section 230 may use this predictive model to generate the constraint conditions. As an example, for each pair (the evaluation target i and the evaluation target j) in the pair collection R₌^{(u)} indicating that “the evaluation target i and the evaluation target j are equal” in the learning data, the generating section 230 generates an inequation such that the absolute value of a value obtained by adding the error variable σᵢⱼ corresponding to the pair of the evaluation target i and the evaluation target j to the difference between an evaluation value f_{w}′(x⁽ⁱ⁾) of the new evaluation function for the evaluation target i and an evaluation value f_{w}′(x^{(j)}) of the new evaluation function for the evaluation target j is less than or equal to the first evaluation threshold value zᵤ₀. For example, the generating section 230 generates the inequation shown in Expression 14.

−zᵤ₀≦f_{w}′(x⁽ⁱ⁾)−f_{w}′(x^{(j)})+ωᵢ−ωⱼ+σᵢⱼ^{(u)}≦zᵤ₀ Expression 14:
for each (i, j)εR_{≈}^{(u)} for each uεU

As another example, for each pair (the evaluation target i and the evaluation target j) in the pair collection R_{>}^{(u)} indicating that “the evaluation target i is slightly better than the evaluation target j” in the learning data, the generating section 230 generates an inequation such that the absolute value of a value obtained by adding the error variable σᵢⱼ corresponding to the pair of the evaluation target i and the evaluation target j to the difference between an evaluation value f_{w}′(x⁽ⁱ⁾) of the new evaluation function for the evaluation target i and an evaluation value f_{w}′(x^{(j)}) of the new evaluation function for the evaluation target j is greater than or equal to the first evaluation threshold value zᵤ₀ and less than or equal to a second evaluation threshold value zᵤ₁. For example, the generating section 230 generates the inequation shown in Expression 15.

zᵤ₀≦f_{w}′(x⁽ⁱ⁾)−f_{w}′(x^{(j)})+ωᵢ−ωⱼ+σᵢⱼ^{(u)}≦zᵤ₁ Expression 15:
for each (i, j)εR_{>}^{(u)} for each uεU

As another example, for each pair (the evaluation target i and the evaluation target j) in the pair collection R_{>>}^{(u)} indicating that “the evaluation target i is significantly better than the evaluation target j” in the learning data, the generating section 230 generates an inequation such that the absolute value of a value obtained by adding the error variable σᵢⱼ corresponding to the pair of the evaluation target i and the evaluation target j to the difference between an evaluation value f_{w}′(x⁽ⁱ⁾) of the new evaluation function for the evaluation target i and an evaluation value f_{w}′(x^{(j)}) of the new evaluation function for the evaluation target j is greater than or equal to the second evaluation threshold value zᵤ₁. For example, the generating section 230 generates the inequation shown in Expression 16.

zᵤ₁≦f_{w}(x⁽ⁱ⁾)−f_{w}(x^{(j)})+ωᵢ−ωⱼ+σᵢⱼ^{(u)} Expression 16:
for each (i, j)εR_{>>}^{(u)} for each uεU

The generating section 230 may generate the objective function together with the constraint conditions. For example, the generating section 230 generates the objective function including the total sum of the absolute values of the error variables σᵢⱼ included in constraint conditions. As another example, the generating section 230 may add the total sum of the decision variables ωᵢ to the objective function. The generating section 230 adds the total sum of the decision variables ωᵢ to the objective function and prevents the effect of the unknown term from being too great. As an example, the generating section 230 generates the objective function shown in Expression 17.

$${min}_{w , y} {λ}_{1} {\sum }_{i , j} \vert {σ}_{ij}^{( u )} \vert + {λ}_{2} {\sum }_{i} \vert {ω}_{i} \vert \qquad Expression 17$$

Here, λ₁ and λ₂ are predetermined constants (e.g. 1) and determine the balance between the total sum of the error variables σᵢⱼ and the total sum of the decision variables ωᵢ. The generating section 230 may optimize λ₁ and λ₂ using cross-validation after fixing the variables such as the error variables σᵢⱼ.

Next, at S350, the determining section 250 may optimize the value of each variable including a weighting using the objective function containing the error variables and/or the total number of basis functions included in the evaluation function. For example, the determining section 250 determines values for the weighting wₖₗ, the evaluation threshold values zᵤ₀ and zᵤ₁, and the decision variable ωᵢ of each of the plurality of basis functions for one or more characteristics in the evaluation function, in a manner to optimize the output value of the objective function while satisfying the constraint conditions generated at S330.

As explained above, the mathematical programming problem generated by the generating section 230 can be easily solved by the same operation as performed by the generating section 130 and the determining section 150 of the generation apparatus 100 according to the embodiment described in FIG. 4. In other words, for the mathematical programming problem generated by the generating section 230, the optimization problem of an objective function having constraint conditions is an MIP problem, and therefore the determining section 250 can perform the processing of S350 using a known solver.

Next, at S370, the extracting section 270 may extract the set of the first evaluation target and the second evaluation target. Here, the K feature values of the first evaluation target are each respectively larger than the K characteristic values of the second evaluation target, and the decision variable ω of the first evaluation target is smaller than the decision variable ω of the second evaluation target. The extracting section 270 may extract such a set of the first evaluation target and the second evaluation target, and supply the output section 290 with this set.

Next, at S390, the output section 290 may present the evaluating subject with the set of the first evaluation target and the second evaluation target. In this way, the evaluating subject can compare the first evaluation target and second evaluation target and observe that the second evaluation target has a lower evaluation than the first evaluation target for all known evaluation criteria but a higher evaluation than the first evaluation target for the latent evaluation criterion. For example, the evaluating subject can compare these evaluation targets and observe that the second evaluation target has a lower evaluation than the first evaluation target for “filling rate,” “ease of sterilization,” and “vertical-horizontal balance” but a higher evaluation than the first evaluation target for “surface area of bottom surface.” In this way, the evaluating subject can easily realize that the second evaluation target is better than the first evaluation target with regard to “surface area of bottom surface.”

In this way, the apparatus 200 extracts and outputs the second evaluation target with a high evaluation only for the latent evaluation criterion together with the first evaluation target with a high evaluation for the evaluation criteria other than the latent evaluation criterion, and therefore provides the evaluating subject with the chance to realize the latent evaluation criterion. If the evaluating subject realizes the latent evaluation criterion, this evaluation criterion may be added to the known evaluation criteria. In this case, the apparatus 200 may further include an input section that is operable to receive and input designations of evaluation criteria to be added to the plurality of evaluation criteria from the user. In this way, the apparatus 200 further accumulates learning data and can calculate an evaluation function that more accurately reproduces the evaluation results.

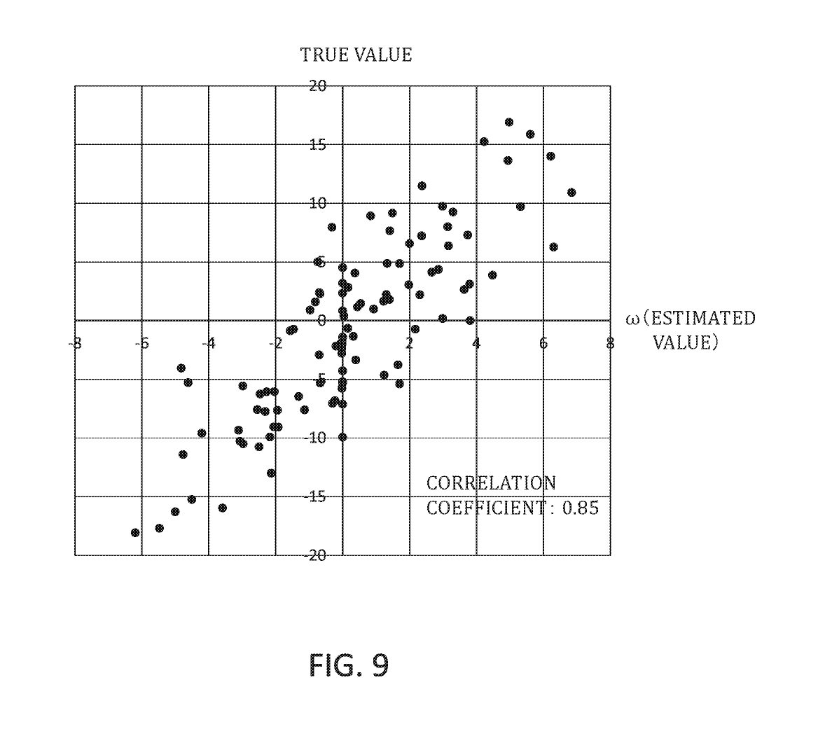

FIG. 9 shows exemplary results obtained by simulating the operation of the apparatus 200 according to the present embodiment. FIG. 9 shows an example of results obtained by generating the true value of an artificially unknown evaluation value and performing a simulation to calculate an estimated value ω for this true value. In FIG. 9, the horizontal axis indicates the estimated value ω for the unknown evaluation value and the vertical axis indicates the artificially generated true value. The simulation results shown in FIG. 9 show a correlation coefficient of 0.85 between the estimated value ω and the true value. Generally, a correlation coefficient exceeding 0.7 is said to indicate a strong correlation, and therefore it is understood that the apparatus 200 can accurately predict the true value.

The apparatus 200 according to the present embodiment described above is an example in which the inequations shown in Expressions 14 to 16 are used as the constraint conditions, but the present invention is not limited to this. For example, the generating section 230 may generate at least some of the constraint conditions shown in Expressions 1 to 11 generated by the generating section 130.

As described above, the apparatus 200 according to the present embodiment can elicit latent evaluation criteria and generate the objective function based on suitable evaluation criteria. The apparatus 200 of the present embodiment describes an example in which the evaluating subject is presented with the set of the first evaluation target and the second evaluation target. Here, the number of first evaluation targets and second evaluation targets being presented is preferably greater. Furthermore, the differences between the evaluation values of the first evaluation targets and the second evaluation targets are preferably greater.

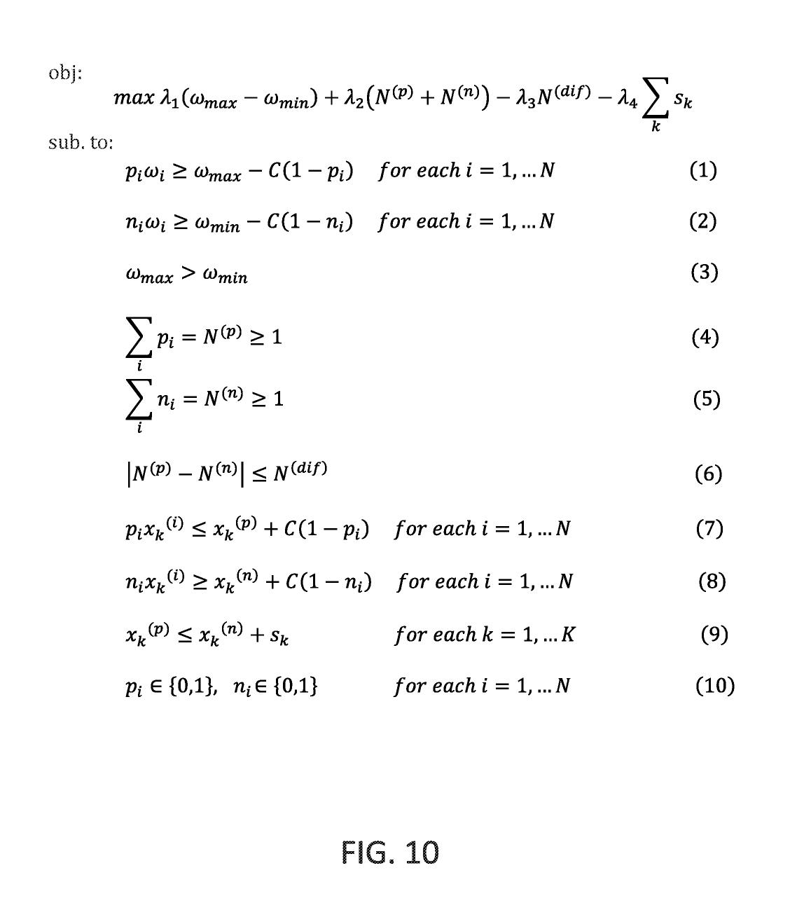

Therefore, the extracting section 270 may use the decision variable ωᵢ and the weighting wₖₗ of the objective function determined by the determining section 250 to extract a more preferable set of the first evaluation target and the second evaluation target. For example, by solving the integer programming problem shown in FIG. 10, the extracting section 270 may maximize the number of first evaluation targets and the number of second evaluation targets, balance the number of the first evaluation targets and the number of second evaluation targets to be equal, or maximize the differences between the evaluation values for all evaluation criteria.

FIG. 10 shows an integer programming problem used by the extracting section 270 according to the present embodiment. As shown by the integer programming problem shown in FIG. 10, for example, the extracting section 270 may be operable to extract a set of a plurality of first evaluation targets and a plurality of second evaluation targets from the plurality of evaluation targets, using the objective function including a term corresponding to the difference in the values of unknown terms between the plurality of first evaluation targets and the plurality of second evaluation targets.

Here, the upper bound of the unknown term of the plurality of first evaluation targets is set as ωₘᵢₙ and the lower bound of the unknown term of the plurality of second evaluation targets is set as ωₘₐₓ. The objective function may include setting λ₁(ωₘₐₓ−ωₘᵢₙ) to a maximum. Here, max{λ₁(ωₘₐₓ−ωₘᵢₙ)} means maximizing the difference in the decision variables ωᵢ between the plurality of first evaluation targets and the plurality of second evaluation targets. Furthermore, the coefficient λ₁ is a weighting for the term (ωₘₐₓ−ωₘᵢₙ). By adjusting the coefficient λ₁, the extracting section 270 may adjust the difference in the decision variables ωᵢ between the plurality of extracted first evaluation targets and the plurality of extracted second evaluation targets.

The extracting section 270 may use the objective function further including a term corresponding to the number of first evaluation targets and second evaluation targets. Here, the number of first evaluation targets is set as N⁽ⁿ⁾, the number of second evaluation targets is set as N^{(p)}, and the difference between the number of first evaluation targets and the number of second evaluation targets is set as N^{(dif)}. The objective function may include maximizing λ₂(N^{(p)}+N⁽ⁿ⁾) and/or −λ₃N^{(dif)}.

Here, max{λ₂(N^{(p)}+N⁽ⁿ⁾)−λ₃N^{(dif)}} means maximizing the number of first evaluation targets and second evaluation targets while minimizing the difference between the number of first evaluation targets and the number of second evaluation targets. Furthermore, the coefficients λ₂ and λ₃ indicate the weights for the terms corresponding to the number of first evaluation targets and the number of second evaluation targets. By adjusting the coefficient λ₂ and/or the coefficient λ₃, the extracting section 270 may adjust the number of extracted first evaluation targets N⁽ⁿ⁾ and the number of extracted second evaluation targets N^{(p)}.

The extracting section 270 may use the objective function further including a term that utilizes a slack variable sₖ. The slack variable sₖ is a variable that is used to avoid unsolvable states and loosen the constraint conditions in response to larger values. The objective function may include maximizing −λ₄Σsₖ. Here, max{−λ₄Σsₖ} means minimizing the slack variable sₖ. The coefficient λ₄ indicates a weighting for the term of the slack variable sₖ. By adjusting the coefficient λ₄, the extracting section 270 may adjust the number of solutions (e.g. the number of first evaluation targets and/or second evaluation targets).

As described above, the extracting section 270 may use the objective function shown in FIG. 10. Furthermore, the extracting section 270 may use the constraint conditions shown by (1) to (10) in FIG. 10. The constraint condition (1) indicates that, if an i-th evaluation target among N evaluation targets from 1 to N is included as a second evaluation target, pᵢ becomes 1 and the decision variable ωᵢ becomes greater than or equal to ωₘₐₓ. Here, pᵢ indicates whether the i-th evaluation target is included as a second evaluation target, and is a variable having a value of 1 or 0. For example, pᵢ=1 if the i-th evaluation target is included as a second evaluation target, and pᵢ=0 if the i-th evaluation target is not included as a second evaluation target. Furthermore, C indicates a positive constant that is sufficiently greater than ωₘₐₓ, and the constraint condition (1) is an expression that is always established if pᵢ=0.

The constraint condition (2) indicates that, if an i-th evaluation target is included as a first evaluation target, nᵢ becomes 1 and the decision variable ωᵢ becomes less than or equal to ωₘᵢₙ. Here, nᵢ indicates whether the i-th evaluation target is included as a first evaluation target, and is a variable having a value of 1 or 0. For example, nᵢ=1 if the i-th evaluation target is included as a first evaluation target, and nᵢ=0 if the i-th evaluation target is not included as a first evaluation target. Furthermore, C indicates a positive constant that is sufficiently greater than ωₘₐₓ, and the constraint condition (2) is an expression that is always established if nᵢ=0.

The constraint condition (3) indicates that ωₘₐₓ is greater than or equal to ωₘᵢₙ. The constraint condition (4) indicates that the total sum of pᵢ values is the number N^{(p)} of second evaluation targets. Furthermore, the constraint condition (4) indicates that N^{(p)} is greater than or equal to 1. The constraint condition (5) indicates that the total sum of nᵢ values is the number N⁽ⁿ⁾ of first evaluation targets. Furthermore, the constraint condition (5) indicates that N⁽ⁿ⁾ is greater than or equal to 1. The constraint condition (6) indicates that the difference |N^{(p)}−N⁽ⁿ⁾| between the number of first evaluation targets and the number of second evaluation targets is less than or equal to N^{(dif)}.

The constraint condition (7) indicates that, if the i-th evaluation target is included as a second evaluation target, the value xₖ⁽ⁱ⁾ of the k-th evaluation criterion is less than or equal to the upper bound xₖ^{(p)} of the known evaluation criterion k for the second evaluation target. The constraint condition (8) indicates that, if the i-th evaluation target is included as a first evaluation target, the value xₖ⁽ⁱ⁾ of the k-th evaluation criterion is greater than or equal to the lower bound xₖ⁽ⁿ⁾ of the known evaluation criterion k for the first evaluation target.

The constraint condition (9) indicates that the upper bound xₖ^{(p)} of the evaluation criterion k for the second evaluation target is less than or equal to a value obtained by adding the slack variable sₖ to the lower bound xₖ⁽ⁿ⁾ of the evaluation criterion k for the first evaluation target. The constraint condition (9) is established for all K values of the evaluation criteria k from 1 to K. Ideally, the slack variable sₖ is preferably 0, in which case xₖ^{(p)} is less than or equal to xₖ⁽ⁿ⁾. The constraint condition (10) indicates that pᵢ and nᵢ are variables having values of 1 or 0.

As described above, the extracting section 270 may extract a plurality of first evaluation targets and a plurality of second evaluation targets, with the constraint condition being a phenomenon of evaluation reversal whereby the first evaluation target has higher evaluations than the second evaluation target for all known evaluation criteria and the first evaluation target has a lower evaluation than the second evaluation target for the unknown evaluation criterion. In this way, the extracting section 270 can extract a collection of two solutions that evoke unknown evaluation criteria.

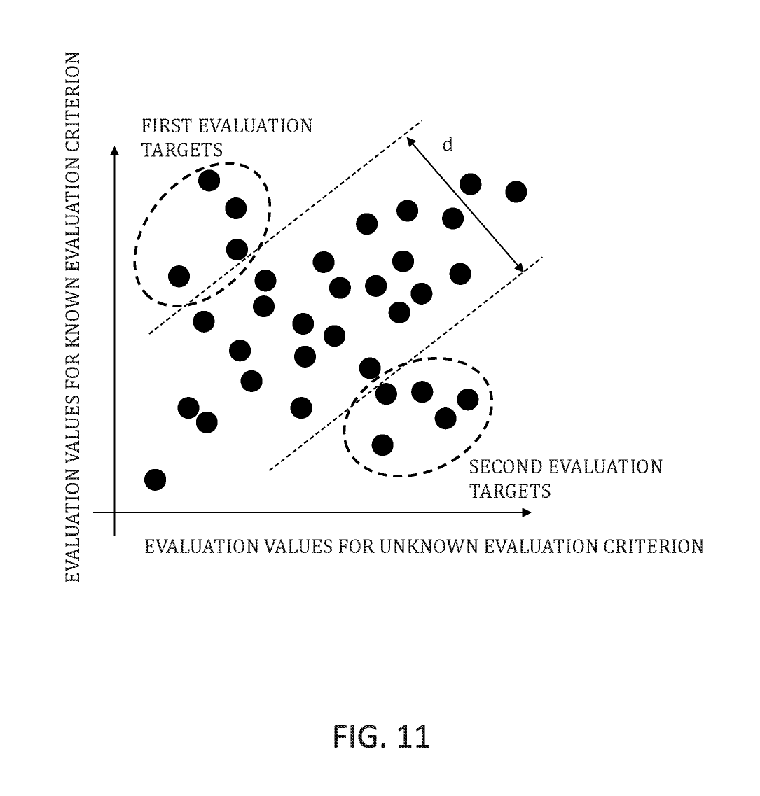

FIG. 11 shows an exemplary overview of first evaluation targets and second evaluation targets extracted by the extracting section 270 according to the present embodiment. In FIG. 11, the horizontal axis indicates the evaluation values for the unknown evaluation criterion, and the vertical axis indicates the evaluation values for the known evaluation criterion. Although a plurality of known evaluation criteria are usually set, for ease of explanation, FIG. 11 shows an example in which there is only one known evaluation criterion plotted on the vertical axis.

The extracting section 270 may extract, as first evaluation targets, evaluation targets that have high evaluation values for the known evaluation criterion and low evaluation values for the unknown evaluation criterion, from among the plurality of evaluation targets. Furthermore, the extracting section 270 may extract, as second evaluation targets, evaluation targets that have low evaluation values for the known evaluation criterion and high evaluation values for the unknown evaluation criterion, from among the plurality of evaluation targets. By solving the integer programming problem shown in FIG. 10, the extracting section 270 can extract a greater number (N^{(p)} and N⁽ⁿ⁾) of the first evaluation targets and second evaluation targets while maximizing the distance d between the group of first evaluation targets and the group of second evaluation targets, for example.

The apparatus 200 according to the present embodiment described above uses a plurality of known evaluation criteria and a term corresponding to an unknown evaluation criterion to generate the constraint conditions and the objective function and to extract the first evaluation targets and the second evaluation targets. If the evaluating subject has realized a new evaluation criterion by observing the first evaluation targets and second evaluation targets, the apparatus 200 may update the evaluation criteria by adding this newly realized evaluation criterion to the plurality of known evaluation criteria. Furthermore, the apparatus 200 uses the updated evaluation criteria and a term corresponding to the next unknown evaluation criterion to generate the constraint conditions and the objective function and to extract new first evaluation targets and second evaluation targets.

In other words, based on the learning data, the generating section 230 may further generate constraint conditions to be satisfied by the value of the evaluation function including a weighting for each of the evaluation criteria to which evaluation criteria designated by the user have been added and an unknown term for each evaluation target corresponding to the new unknown evaluation criterion that is not part of the plurality of evaluation criteria. If the evaluating subject has realized an evaluation criterion, the apparatus 200 sequentially presents the evaluating subject with sets of evaluation targets to cause the evaluating subject to realize a further evaluation criterion, and can generate the objective function accurately corresponding to the evaluation of the evaluating subject.

The apparatus 200 according to the present embodiment is an example in which the evaluating subject is made to realize an unknown evaluation criterion in order to improve the accuracy of the evaluation function generated by the generation apparatus 10, but the present invention is not limited to this. If an optimization problem or the like is being designed, the apparatus 200 may evaluate whether the generated objective function is designed based on a sufficient number of evaluation criteria, based on the value of the decision variable ω. The apparatus 200 can generate a more preferable objective function by extracting and presenting the first evaluation targets and the second evaluation targets if the value of the decision variable w is greater than the a predetermined value.

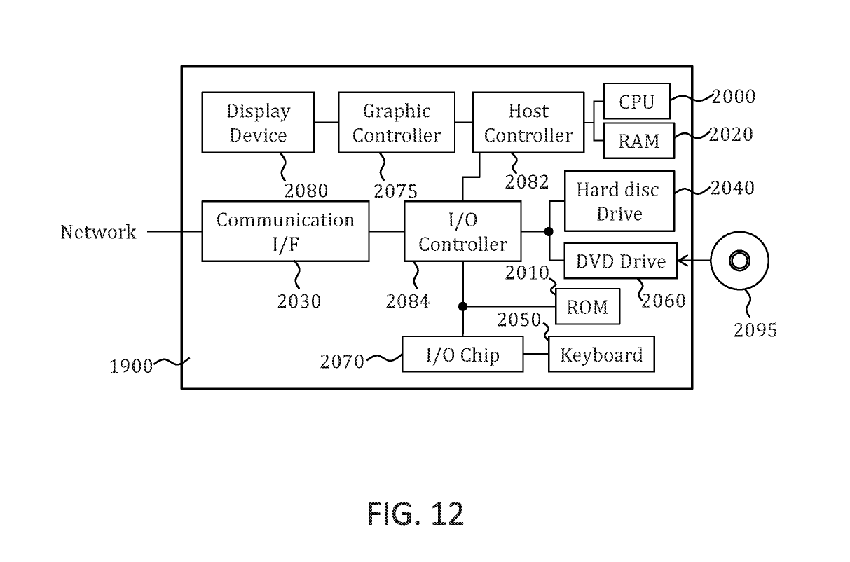

FIG. 12 shows an exemplary configuration of a computer 1900 according to an embodiment of the invention. The computer 1900 according to the present embodiment includes a CPU 2000, a RAM 2020, a graphics controller 2075, and a display apparatus 2080 which are mutually connected by a host controller 2082. The computer 1900 also includes input/output units such as a communication interface 2030, a hard disk drive 2040, and a DVD-ROM drive 2060 which are connected to the host controller 2082 via an input/output controller 2084. The computer also includes legacy input/output units such as a ROM 2010 and a keyboard 2050 which are connected to the input/output controller 2084 through an input/output chip 2070.

The host controller 2082 connects the RAM 2020 with the CPU 2000 and the graphics controller 2075 which access the RAM 2020 at a high transfer rate. The CPU 2000 operates according to programs stored in the ROM 2010 and the RAM 2020, thereby controlling each unit. The graphics controller 2075 obtains image data generated by the CPU 2000 on a frame buffer or the like provided in the RAM 2020, and causes the image data to be displayed on the display apparatus 2080. Alternatively, the graphics controller 2075 may contain therein a frame buffer or the like for storing image data generated by the CPU 2000.

The input/output controller 2084 connects the host controller 2082 with the communication interface 2030, the hard disk drive 2040, and the DVD-ROM drive 2060, which are relatively high-speed input/output units. The communication interface 2030 communicates with other electronic devices via a network. The hard disk drive 2040 stores programs and data used by the CPU 2000 within the computer 1900. The DVD-ROM drive 2060 reads the programs or the data from the DVD-ROM 2095, and provides the hard disk drive 2040 with the programs or the data via the RAM 2020.

The ROM 2010 and the keyboard 2050 and the input/output chip 2070, which are relatively low-speed input/output units, are connected to the input/output controller 2084. The ROM 2010 stores therein a boot program or the like executed by the computer 1900 at the time of activation, a program depending on the hardware of the computer 1900. The keyboard 2050 inputs text data or commands from a user, and may provide the hard disk drive 2040 with the text data or the commands via the RAM 2020. The input/output chip 2070 connects a keyboard 2050 to an input/output controller 2084, and may connect various input/output units via a parallel port, a serial port, a keyboard port, a mouse port, and the like to the input/output controller 2084.

A program to be stored on the hard disk drive 2040 via the RAM 2020 is provided by a recording medium as the DVD-ROM 2095, and an IC card. The program is read from the recording medium, installed into the hard disk drive 2040 within the computer 1900 via the RAM 2020, and executed in the CPU 2000.

A program that is installed in the computer 1900 and causes the computer 1900 to function as an apparatus, such as the apparatus 100 of FIG. 1 and the apparatus 200 of FIG. 7, includes an acquiring section, a generating section, a determining section, a judging section, a presenting section, a extracting section, an output section. The program or module acts on the CPU 2000, to cause the computer 1900 to function as a section, component, and element such as the acquiring section 110, the generating section 130, the determining section 150, the judging section 170, the presenting section 190, the acquiring section 210, the generating section 230, the determining section 250, the extracting section 270, the output section 290, described above.

The information processing described in these programs is read into the computer 1900, to function as the determining section, which is the result of cooperation between the program or module and the above-mentioned various types of hardware resources. Moreover, the apparatus is constituted by realizing the operation or processing of information in accordance with the usage of the computer 1900.

For example when communication is performed between the computer 1900 and an external device, the CPU 2000 may execute a communication program loaded onto the RAM 2020, to instruct communication processing to a communication interface 2030, based on the processing described in the communication program. The communication interface 2030, under control of the CPU 2000, reads the transmission data stored on the transmission buffering region provided in the recording medium, such as a RAM 2020, a hard disk drive 2040, or a DVD-ROM 2095, and transmits the read transmission data to a network, or writes reception data received from a network to a reception buffering region or the like provided on the recording medium. In this way, the communication interface 2030 may exchange transmission/reception data with the recording medium by a DMA (direct memory access) method, or by a configuration that the CPU 2000 reads the data from the recording medium or the communication interface 2030 of a transfer destination, to write the data into the communication interface 2030 or the recording medium of the transfer destination, so as to transfer the transmission/reception data.

In addition, the CPU 2000 may cause all or a necessary portion of the file of the database to be read into the RAM 2020 such as by DMA transfer, the file or the database having been stored in an external recording medium such as the hard disk drive 2040, the DVD-ROM drive 2060 (DVD-ROM 2095) to perform various types of processing onto the data on the RAM 2020. The CPU 2000 may then write back the processed data to the external recording medium by means of a DMA transfer method or the like. In such processing, the RAM 2020 can be considered to temporarily store the contents of the external recording medium, and so the RAM 2020, the external recording apparatus, and the like are collectively referred to as a memory, a storage section, a recording medium, a computer readable medium, etc. Various types of information, such as various types of programs, data, tables, and databases, may be stored in the recording apparatus, to undergo information processing. Note that the CPU 2000 may also use a part of the RAM 2020 to perform reading/writing thereto on the cache memory. In such an embodiment, the cache is considered to be contained in the RAM 2020, the memory, and/or the recording medium unless noted otherwise, since the cache memory performs part of the function of the RAM 2020.

The CPU 2000 may perform various types of processing, onto the data read from the RAM 2020, which includes various types of operations, processing of information, condition judging, search/replace of information, etc., as described in the present embodiment and designated by an instruction sequence of programs, and writes the result back to the RAM 2020. For example, when performing condition judging, the CPU 2000 may judge whether each type of variable shown in the present embodiment is larger, smaller, no smaller than, no greater than, or equal to the other variable or constant, and when the condition judging results in the affirmative (or in the negative), the process branches to a different instruction sequence, or calls a sub routine.

In addition, the CPU 2000 may search for information in a file, a database, etc., in the recording medium. For example, when a plurality of entries, each having an attribute value of a first attribute is associated with an attribute value of a second attribute, are stored in a recording apparatus, the CPU 2000 may search for an entry matching the condition whose attribute value of the first attribute is designated, from among the plurality of entries stored in the recording medium, and reads the attribute value of the second attribute stored in the entry, thereby obtaining the attribute value of the second attribute associated with the first attribute satisfying the predetermined condition.

The above-explained program or module may be stored in an external recording medium. Exemplary recording mediums include a DVD-ROM 2095, as well as an optical recording medium such as a Blu-ray Disk or a CD, a magneto-optic recording medium such as a MO, a tape medium, and a semiconductor memory such as an IC card. In addition, a recording medium such as a hard disk or a RAM provided in a server system connected to a dedicated communication network or the Internet can be used as a recording medium, thereby providing the program to the computer 1900 via the network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention are capable of eliciting latent evaluation criteria and supporting the design of a more accurate objective function.

What is claimed is:

1. An apparatus comprising:
a processor; and
one or more computer readable mediums collectively including instructions that, when executed by the processor, cause the processor to:
acquire learning data that includes an evaluation of evaluation targets;
generate a constraint condition to be satisfied by a value of an evaluation function that includes a weighting for each of a plurality of evaluation criteria of the evaluation target and an unknown term for each evaluation target corresponding to an unknown evaluation criterion that is not among the plurality of evaluation criteria, based on the learning data;
determine a value of the unknown term and the weighting for each evaluation criterion in the evaluation function in a manner that satisfies the constraint condition;
extract a set of evaluation targets for which an evaluation of each evaluation criterion is opposite of an evaluation based on the unknown term, from among the plurality of evaluation targets; and
output the extracted set of evaluation targets.

2. The apparatus according to claim 1, wherein the extracting includes extracting, from the plurality of evaluation targets, a set of a first evaluation target and a second evaluation target, and wherein the second evaluation target has:
lower evaluation values, for all of the evaluation criteria, than the first evaluation target; and
a higher evaluation value, for an evaluation based on the unknown term, than the first evaluation target.

3. The apparatus according to claim 2, wherein:
the extracting includes extracting. from the plurality of evaluation targets, a set of a plurality of first evaluation targets and a plurality of second evaluation targets by using an objective function including a term corresponding to a difference in the unknown term between the plurality of first evaluation targets and the plurality of second evaluation targets.

4. The apparatus according to claim 3, wherein:
the extracting includes using the objective function, further including a term corresponding to the number of the first evaluation targets and the second evaluation targets.

5. The apparatus according to claim 4, wherein:
the extracting includes adjusting the number of the first evaluation targets and the second evaluation targets that are extracted, by adjusting a coefficient of a term corresponding to the number of the first evaluation targets and the second evaluation targets.

6. The apparatus according to claim 1, wherein:
the outputting includes outputting the extracted set of evaluation targets to a user; and
the processor is further caused to receive, from the user, designation of an evaluation criterion to be added to the plurality of evaluation criteria.

7. The apparatus according to claim 6, wherein:
the generating includes further generating, based on the learning data, the constraint condition to be satisfied by the value of the evaluation function including a weighting for each evaluation criterion added according to the designation made by the user and an unknown term for each evaluation target corresponding to a new unknown evaluation criterion that is not among the plurality of evaluation criteria.

8. The apparatus according to claim 1, wherein:
the acquiring includes acquiring the learning data that includes, as the evaluation, a qualitative evaluation that is a comparison result obtained by qualitatively comparing two or more evaluation targets.

9. The apparatus according to claim 8, wherein:
the acquiring includes acquiring the learning data that further includes, as the evaluation, a comparison result obtained by qualitatively comparing the evaluation targets to a predetermined evaluation standard.

10. The apparatus according to claim 8, wherein:
the generating includes generating, as the constraint condition, an inequation that includes a difference in evaluation values of the evaluation function for two or more of the evaluation targets being compared and an evaluation threshold value that serves as a standard for the qualitative evaluation; and
the determining includes determining the evaluation threshold value in a manner to satisfy the constraint condition.

11. The apparatus according to claim 10, wherein:
the acquiring includes acquiring the learning data including a plurality of the qualitative evaluations made by a plurality of evaluating subjects; and
the generating includes generating, as the constraint condition, an inequation that includes the evaluation threshold value for each evaluating subject.

12. The apparatus according to claim 11, wherein:
the processor is further caused to judge whether the difference in the evaluation values between the two or more evaluation targets according to the evaluation function based on the weighting determined during the determining is within a predetermined reference range relative to the evaluation threshold value; and
the acquiring includes acquiring an additional qualitative evaluation and adding the additional qualitative evaluation to the learning data, in response to the difference in evaluation values being judged to be within the reference range relative to the evaluation threshold value.

13. The apparatus according to claim 12, wherein:
the processor is further caused to present the evaluating subject with the two or more evaluation targets for which the difference in the evaluation values therebetween is within the reference range; and
the acquiring includes acquiring the qualitative evaluation made by the evaluating subject for the presented two or more evaluation targets, and adding the acquired qualitative evaluation to the learning data.

14. The apparatus according to claim 1, wherein:
the generating includes generating the constraint condition based on the evaluation function that includes the unknown term and a term that is based on a total weighting of a plurality of basis functions into which are input a characteristic value for each evaluation criterion of the evaluation targets; and
the determining includes determining the unknown term and the weighting of each of the plurality of basis functions such that the constraint condition is satisfied.

15. The apparatus according to claim 14, wherein:
the generating includes generating the constraint condition including a variable that indicates whether each of the plurality of basis functions is included; and
the determining includes optimizing the weighting by using an objective function including the total number of basis functions included in the evaluation function.

16. The apparatus according to claim 15, wherein:
the generating includes generating the objective function including an error variable; and
the determining includes optimizing the weighting by using the objective function including the error variable.

17. A computer program product comprising a non-transitory computer readable storage medium having program instructions embodied therewith, the program instructions executable by a computer to cause the computer to:
acquire learning data that includes an evaluation of evaluation targets;
generate a constraint condition to be satisfied by a value of an evaluation function that includes a weighting for each of a plurality of evaluation criteria of the evaluation target and an unknown term for each evaluation target corresponding to an unknown evaluation criterion that is not among the plurality of evaluation criteria, based on the learning data;
determine a value of the unknown term and the weighting for each evaluation criterion in the evaluation function in a manner that satisfies the constraint condition;
extract a set of evaluation targets for which an evaluation of each evaluation criterion is opposite of an evaluation based on the unknown term, from among the plurality of evaluation targets; and
output the extracted set of evaluation targets.

18. A method comprising:
acquiring learning data that includes an evaluation of evaluation targets;
generating a constraint condition to be satisfied by a value of an evaluation function that includes a weighting for each of a plurality of evaluation criteria of the evaluation target and an unknown term for each evaluation target corresponding to an unknown evaluation criterion that is not among the plurality of evaluation criteria, based on the learning data;
determining a value of the unknown term and the weighting for each evaluation criterion in the evaluation function in a manner that satisfies the constraint condition;
extracting a set of evaluation targets for which an evaluation of each evaluation criterion is opposite of an evaluation based on the unknown term, from among the plurality of evaluation targets; and
outputting the extracted set of evaluation targets.
